(19) United States
(12) Patent Application Publication
(10) Pub. No.: US 2022/0057520 A1
(43) Pub. Date: Feb. 24, 2022

(54) DISTANCE MEASUREMENT APPARATUS AND DISTANCE MEASUREMENT METHOD

(71) Applicant: SONY SEMICONDUCTOR SOLUTIONS CORPORATION, KANAGAWA (JP)

(72) Inventor: KUMIKO MAHARA, KANAGAWA (JP)

(21) Appl. No.: 17/419,432

(22) PCT Filed: Dec. 13, 2019
(86) PCT No.: PCT/JP2019/048938

§ 371 Date: Jun. 29, 2021

(30) Foreign Application Priority Data
Jan. 11, 2019 (JP) 2019-003543

(51) Int. Cl. G01S 17/894; G01S 17/10; G01S 7/4865

(52) U.S. Cl. CPC G01S 17/894; G01S 7/4865; G01S 17/10

(57) ABSTRACT

A distance measurement apparatus includes a light-emitting section adapted to emit light to a target area, a light-receiving section including a plurality of light-receiving elements that receives observation light in the target area to output an electric signal, a distance measurement process section adapted to perform, according to predetermined distance measurement conditions and in a captured image frame formed by the plurality of light-receiving elements, a distance measurement process for calculating a distance to an object on the basis of an electric signal commensurate with reflected light from the object to which the light emitted from the light-emitting section has been applied, the reflected light being included in the observation light received by some light-receiving element groups of the plurality of light-receiving elements included in a pixel, and a control section adapted to control the predetermined distance measurement conditions. The control section changes the predetermined distance measurement conditions while the current captured image frame is formed. This makes it possible to change the number of SPADs included in the pixel or the number of sampling frequency while the captured image frame is formed.

### TECHNICAL FIELD

The present technology relates to a distance measurement apparatus and distance measurement method.

### BACKGROUND ART

A distance measurement apparatus (also occasionally referred to as a distance measurement sensor) that measures a distance to an object (target) on the basis of ToF (Time of Flight) is known. TOF includes direct TOF (dTOF) and indirect TOF (iTOF). Direct TOF is a technology that emits pulsed light from a light-emitting element, detects photons by receiving reflected light from the object with light-receiving elements referred to as SPADs (Single Photo Avalanche Diodes), converts carriers that arise therefrom into an electric signal by using avalanche multiplication, measures an arrival time of day by feeding the electric signal into a TDC (Time to Digital Converter), and measures the distance to the object.

The distance measurement apparatus using the SPADs commonly calculates the distance by creating, for a single pulsed light beam, a histogram obtained by adding responses of several SPADs included in a pixel for each split time according to a sampling frequency and adopting the time of day corresponding to a peak value therefrom. In direct TOF, the reflected beam (photons) resulting from emission of the single pulsed light beam is detected by the SPADs. As a result, whether or not the photons arrive is a stochastic event due to the distance to the object and effects of ambient light (external disturbance light). Accordingly, the distance measurement apparatus using the SPADs enhances a distance measurement accuracy by creating a histogram of cumulative responses of the SPADs resulting from the emission of light a plurality of times (e.g., several to several thousand times) within a predetermined unit time. As described above, the distance measurement apparatus can acquire, in real time, a captured image frame (distance image) having distance information for each pixel by reading out photons for each column of the pixels that are arranged linearly.

PTL 1 listed below discloses a technology that calculates, for the histogram created on the basis of an amount of received light observed repeatedly, reliability thereof and halts the creation of the histogram in a case where the calculated reliability of the histogram is equal to or higher than a threshold, in order to reduce unnecessary measurements even in an environment where external disturbance light abounds and changes.

### CITATION LIST

### Patent Literature

### [PTL 1]

JP 2010-091377A

### SUMMARY

### Technical Problems

In order to reduce effects of noise such as external disturbance light in the distance measurement apparatus using an SPAD array, it is necessary to increase the number of SPADs included in the pixel (reduce a resolution), and in order to increase the distance measurement accuracy, it is necessary to increase a sampling frequency for time division.

However, a conventional distance measurement apparatus has not taken into consideration changing of the number of SPADs included in the pixel or the sampling frequency during its operation, and especially while the captured image frame is formed.

In light of the foregoing, the present disclosure provides a technology that allows to change the number of SPADs included in the pixel or the sampling frequency while the captured image frame is formed.

### Solution to Problems

In light of the foregoing, the present technology can include the following matters defining the invention or technical features.

That is, the present technology according to an aspect is directed to a distance measurement apparatus. The distance measurement apparatus includes a light-emitting section adapted to emit light to a target area, a light-receiving section including a plurality of light-receiving elements that receives observation light in the target area to output an electric signal, a distance measurement process section adapted to perform, according to predetermined distance measurement conditions and in a captured image frame formed by the plurality of light-receiving elements, a distance measurement process for calculating a distance to an object on the basis of an electric signal commensurate with reflected light from the object to which the light emitted from the light-emitting section has been applied, the reflected light being included in the observation light received by some light-receiving element groups of the plurality of light-receiving elements included in a pixel, and a control section adapted to control the predetermined distance measurement conditions. The control section can change the predetermined distance measurement conditions while the current captured image frame is formed.

Also, the present technology according to another aspect is directed to a distance measurement method. The method includes emitting light to a target area from a light-emitting section, receiving observation light in the target area with a light-receiving section including a plurality of light-receiving elements and outputting an electric signal, performing, according to predetermined distance measurement conditions and in a captured image frame formed by the plurality of light-receiving elements, a distance measurement process for calculating a distance to an object on the basis of an electric signal commensurate with reflected light from the object to which the light emitted from the light-emitting section has been applied, the reflected light being included in the observation light received by some light-receiving element groups of the plurality of light-receiving elements included in a pixel, and performing control in such a manner as to change the predetermined distance measurement conditions while the current captured image frame is formed so as to ensure that the distance to the object is calculated with a predetermined distance measurement accuracy.

It should be noted that, in the present specification and the like, the term “section” or “means” refers not simply to a physical mechanism, but rather includes a case where a function of the mechanism is realized by software. Also, the functions of one section or means may be realized by two or more physical mechanisms, and two or more sections or means may be realized by a single physical mechanism.

Other technical features, objects, working effects, or advantages of the present technology will become apparent from the following embodiments described below with reference to attached drawings. It should be noted that the working effects described in the present specification are merely illustrative and not restrictive and that there may be other working effects not described herein.

### BRIEF DESCRIPTION OF DRAWINGS

FIG. 1 is a block diagram illustrating a configuration example of a distance measurement apparatus in an embodiment of the present technology.

FIG. 2 is a diagram for describing a captured image frame and pixels included in the captured image frame in the present technology.

FIG. 3 is a diagram for describing a configuration of a sampling circuit of the distance measurement apparatus in an embodiment of the present technology.

FIG. 4 is a diagram for describing a histogram created by the distance measurement apparatus in an embodiment of the present technology.

FIG. 5 is a diagram illustrating an example of distance measurement data acquired by the distance measurement apparatus in an embodiment of the present technology.

FIG. 6 is a diagram illustrating examples of distance measurement conditions of the distance measurement apparatus in an embodiment of the present technology.

FIG. 7 is a flowchart for describing a distance measurement condition changing process by the distance measurement apparatus in an embodiment of the present technology.

FIG. 8 is a diagram for describing a change to the distance measurement conditions during formation of a captured image frame by the distance measurement apparatus in an embodiment of the present technology.

FIG. 9 is a timing chart for describing examples of switching between the distance measurement conditions in the distance measurement apparatus in an embodiment of the present technology.

FIG. 10 is a block diagram illustrating a configuration example of the distance measurement apparatus in an embodiment of the present technology.

FIG. 11 is a diagram for describing the change to the distance measurement conditions during the formation of the captured image frame by the distance measurement apparatus in an embodiment of the present technology.

FIG. 12 is a block diagram illustrating a configuration example of the distance measurement apparatus in an embodiment of the present technology.

### DESCRIPTION OF EMBODIMENTS

A description will be given below of embodiments of the technology according to the present disclosure with reference to drawings. It should be noted, however, that the embodiments described below are merely illustrative and not intended to preclude application of various modifications and technologies that are not clearly stated below. The present technology can be performed by modifying it in various ways (e.g., by combining embodiments) without departing from a gist thereof. Also, in the following description of the drawings, identical or similar portions will be denoted by identical or similar reference signs. The drawings are schematic and dimensions, ratios, and the like in the drawings do not necessarily agree with actual ones. Some portions may also have different dimensional relations or ratios between the drawings.

### First Embodiment

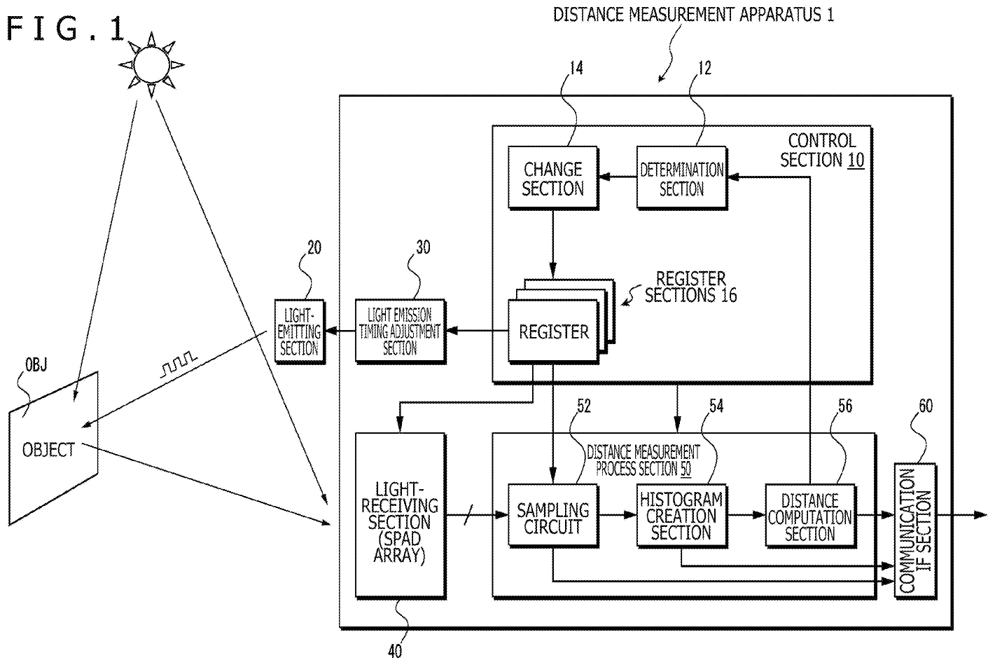

FIG. 1 is a block diagram illustrating a configuration example of a distance measurement apparatus 1 in an embodiment of the present technology. The distance measurement apparatus 1 is a generally-called TOF distance measurement sensor that measures the distance to an object OBJ (target or subject) on the basis of an electric signal acquired by emitting pulsed light from a light-emitting element and receiving reflected light from the object OBJ to which the pulsed light has been applied with light-receiving elements referred to as SPADs (Single Photon Avalanche Diodes).

As illustrated in FIG. 1, the distance measurement apparatus 1 includes, for example, components such as a control section 10, a light-emitting section 20, a light emission timing adjustment section 30, a light-receiving section 40, and a distance measurement process section 50. Although these components can be integrally configured as a system-on-chip (SoC) such as a CMOS LSI, several components such as the light-emitting section 20 and the light-receiving section 40 may be configured as separate LSIs. The distance measurement apparatus 1 operates according to an operating clock that is not illustrated. The distance measurement apparatus 1 also includes a communication interface section (communication IF section) 60 for externally outputting data (distance measurement data) related to the distance calculated by the distance measurement process section 50. The distance measurement apparatus 1 is configured in such a manner as to be able to communicate with a host IC which is, although not illustrated, provided externally via the communication interface section 60. It should be noted that the distance measurement apparatus 1 may include a CMOS image sensor (not illustrated) to interpolate the calculation of the distance.

The control section 10 is a component that controls the operation of the distance measurement apparatus 1 in a centralized manner. Typically, the control section 10 includes a microprocessor. The control section 10 controls, for example, the operation of other components, and, especially, each operation of the light emission timing adjustment section 30, the light-receiving section 40, and the distance measurement process section 50 by changing or adjusting the distance measurement conditions stored in the register section 16, as will be described later. The distance measurement conditions include combinations of various types of parameters for prescribing the distance measurement accuracy. In the present disclosure, the control section 10 includes a determination section 12 and a changing section 14. The determination section 12 determines whether or not to change the distance measurement conditions. The changing section 14 performs the operation to change the distance measurement conditions according to a determination result of the determination section 12. The determination section 12 determines whether or not to change the distance measurement conditions on the basis of external disturbance light or the calculated distance as will be described later. Also, the changing section 14 changes the distance measurement conditions, for example, by switching between registers of a register section 16 as will be described later. Alternatively, the changing section 14 may change the distance measurement conditions by dynamically rewriting contents of the registers of the register section 16.

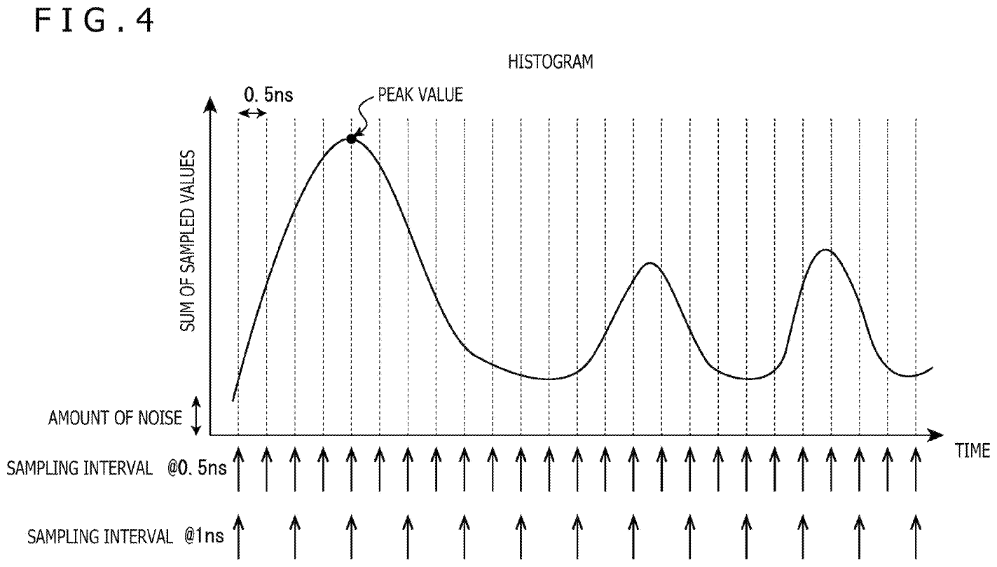

The register section 16 includes the plurality of registers for retaining each of the plurality of distance measurement conditions. Each of the plurality of registers is identified, for example, by a register number. Although the register section 16 is provided outside the control section 10 in FIG. 1, the register section 16 may be provided inside the control section 10, for example, inside the microprocessor. The distance measurement conditions include, for example, the combinations of parameters, each indicating the number of SPADs, the sampling frequency, a SPAD drive voltage, and the like (refer to FIG. 4). In the present disclosure, such a combination of parameters will be referred to as a parameter set. Each of the plurality of registers retains the distance measurement conditions that include different parameter sets.

The distance measurement conditions (parameter sets) retained in the register section 16 are referenced by the light emission timing adjustment section 30, the light-receiving section 40, and the distance measurement process section 50. In other words, each of the light emission timing adjustment section 30, the light-receiving section 40, and the distance measurement process section 50 is configured in such a manner as to operate according to the distance measurement conditions retained in the specific register specified by the register number.

The light-emitting section 20 emits pulsed laser light (hereinafter referred to as “pulsed light”) for TOF distance measurement toward the target area or includes a light source to emit such pulsed light. Pulsed light used for such distance measurement is occasionally referred to as active light. The light source may be, for example, an edge-emitting semiconductor laser or a surface-emitting semiconductor laser. Typically, the light source of the light-emitting section 20 can spatially emit light toward the target area as a whole. Although the light-emitting section 20 is provided outside the LSI chip in the present disclosure, the light-emitting section 20 is not limited to this arrangement.

The light emission timing adjustment section 30 is a circuit that adjusts the light emission timing of the light-emitting section 20. For example, the light emission timing adjustment section 30 drives the light source of the pulsed light by outputting a trigger pulse synchronously with a line-by-line readout timing from the light-receiving section 40 which will be described later according to the distance measurement conditions retained in the register section 16. The pulsed light can typically have a pulse width of several to several tens of ns.

The light-receiving section 40 is a sensor that outputs an electric signal pulse in response to incident light from the target area. The incident light (observation light) includes ambient light that acts as external disturbance light for distance measurement and reflected light from the object OBJ to which the pulsed light, emitted from the light-emitting section 20, has been applied. Although not illustrated, an optical element such as a lens is typically provided in front of a light-receiving surface of the light-receiving section 40 to efficiently receive light.

In the present disclosure, the light-receiving section 40 is a CMOS image sensor that includes a plurality of light-receiving elements (SPADs) that is arranged in a two-dimensional array form. That is, each of the SPADs detects incoming light (photons) and converts carriers that arise therefrom into an electric signal pulse by using avalanche multiplication. In the present disclosure, for example, a specific group of SPADs (e.g., SPAD group in a single line direction in a captured image frame) are enabled according to the distance measurement conditions retained in the register section 16 under control of the control section 10, thus allowing the electric signal pulse to be read out. Also, the SPAD groups in the respective lines are sequentially enabled in a period of time of one frame, and a captured image frame of the target area is formed by the electric signal pulses output from the respective SPAD groups that have been enabled.

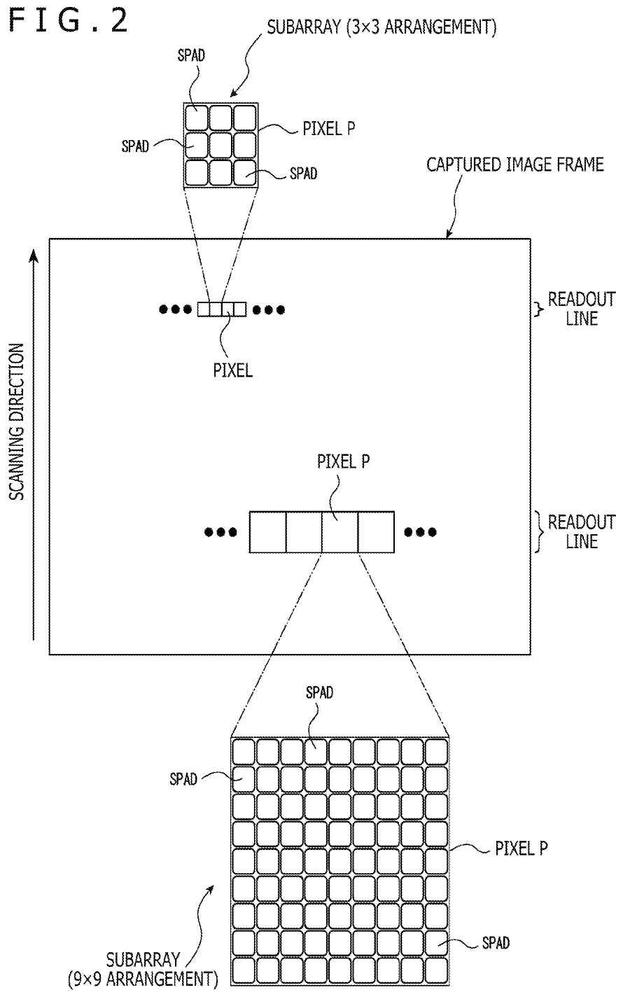

FIG. 2 is a diagram for describing the captured image frame and the pixels included in the captured image frame in the present disclosure. That is, in the present disclosure, a collection of some SPADs adjacent to each other (SPAD group) are referred to as a pixel P. The pixel P includes, for example, a collection of SPADs having an arrangement (array pattern) of an optional number of SPADs adjacent to each other, such as 2×3, 3×3, 3×6, 3×9, 6×3, 6×6, or 9×9 array pattern. However, the pixel P is not limited to these numbers. Also, in the present disclosure, the collection of SPADs included in the pixel P will be referred to as an SPAD subarray (or simply subarray).

A size of the single pixel P depends on the size of the SPAD subarray, that is, the number of SPADs. Meanwhile, the captured image frame includes, for example, all the effective SPADs of the light-receiving section 40, and the size thereof is constant. Accordingly, the larger the size of the pixel P (the larger the number of SPADs included therein), the smaller the number of pixels for the captured image frame, that is, the lower the resolution. Meanwhile, the smaller the size of the pixel P (the smaller the number of SPADs included therein), the larger the number of pixels for the captured image frame, that is, the higher the resolution. Also, the number of SPADs included in the pixel P is proportional to the number of photons that can be detected. Accordingly, the larger the number of SPADs included in the pixel P (the lower the resolution), the higher the SN ratio, thus providing low susceptibility to noise during distance measurement.

The number of SPADs included in the pixel P used for distance measurement, that is, the resolution, is decided, for example, by the distance measurement condition parameters retained in the register section 16. The control section 10 can change the distance measurement conditions to change the resolution as necessary, for example, during the formation of the captured image frame. The distance measurement conditions are changed, for example, by selecting one of the register sections 16 that retains the specific distance measurement conditions.

It should be noted that, in the present disclosure, the SPAD groups are selectively enabled on a line-by-line basis (i.e., one horizontal or vertical pixel column in FIG. 1), after which the electric signal pulses are read out. As will be described later, the size of the pixel P can be changed in a single captured image frame. Accordingly, the line width for outputting the electric signal pulses (the vertical number of SPADs enabled) is controlled in a variable manner.

Referring back to FIG. 1, the distance measurement process section 50 is a component that calculates the distance to the object OBJ on the basis of the pulsed light emitted by the light-emitting section 20 and the observation light received by the light-receiving section 40. The distance measurement process section 50 typically includes a signal processing processor. In the present disclosure, the distance measurement process section 50 includes a sampling circuit 52, a histogram creation section 54, and a distance computation section 56.

The sampling circuit 52 is a component that samples the electric signal pulse output from the specific SPAD group at a predetermined sampling frequency in response to the emission of the pulsed light. As will be described later, the sampling circuit 52, for example, outputs a high or low value (sampled value) according to a value of the electric signal pulse output from each of the enabled SPAD groups and further adds the sampled values corresponding to the SPAD group of the pixel P commensurate with the distance measurement conditions indicated by the register section 16. A sum of the sampled value for each pixel P is output to the histogram creation section 54.

The histogram creation section 54 is a component that creates a histogram as illustrated in FIG. 4 on the basis of the sum of the sampled values for each sampling time (bin) to be output by the sampling circuit 52 (that is, the sum of the photons to be output from the SPAD group corresponding to the pixel P). The histogram is retained, for example, as some kind of data structure or table in a memory that is not illustrated. As many histograms as the number corresponding to the number of SPAD subarrays are created on the basis of the pulsed light emitted for each readout line in the captured image frame. The bin size corresponds to the readout time commensurate with the sampling frequency. The histograms created by the histogram creation section 54 are referenced by the distance computation section 56.

The distance computation section 56 is a component which references each of the created histograms, detects the peak values in the histograms, and calculates the distance from the times corresponding to the peak values (i.e., arrival times). That is, assuming that the reflected light when the emitted pulsed light is applied to the object OBJ is received, the time in question is a round trip time to the object OBJ. As a result, it is possible to calculate the distance to the object OBJ for each pixel P by multiplying this time by c/2 (where c is a speed of light). Accordingly, a distance image can be acquired by the distances calculated for all the pixels P included in the captured image frame. The distance computation section 56 sequentially outputs data (distance measurement data) related to the distance calculated for each pixel P in each captured image frame to the control section 10 and the communication interface section 60.

The communication interface section 60 is an interface circuit for outputting the calculated distance measurement data to an external host IC. For example, the communication interface section 60 is an interface circuit compliant with MIPI (Mobile Industry Processor Interface). However, the communication interface section 60 is not limited thereto. For example, the communication interface section 60 may be an SPI (Serial Peripheral Interface), LVDS, SLVS-EC, or the like. Alternatively, several of these interface circuits may be implemented therein.

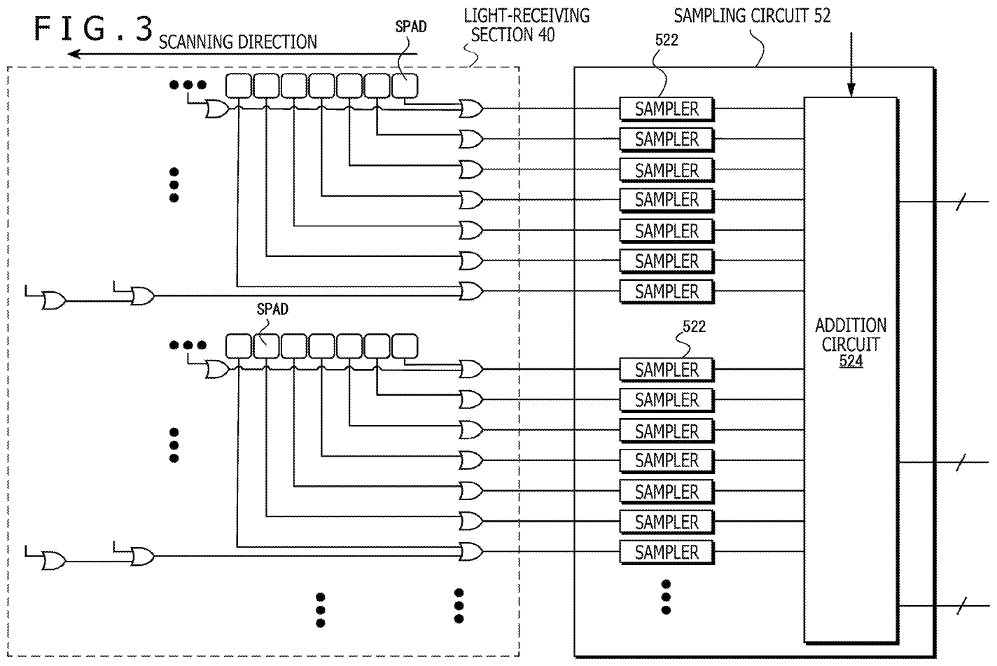

FIG. 3 is a diagram for describing a configuration of the sampling circuit of the distance measurement apparatus 1 in an embodiment of the present technology. As illustrated in FIG. 3, the sampling circuit 52 includes a plurality of samplers 522 and an addition circuit 524.

Each of the plurality of samplers 522 outputs a sampled value commensurate with the value of the electric signal pulse output from the corresponding SPAD. The samplers 522 are provided, for example, in such a manner as to correspond, one to one, to each of the plurality of line-by-line SPADs. That is, the SPAD group in the predetermined readout line is enabled according to the distance measurement conditions indicated by the predetermined register of the register section 16 during distance measurement. As a result, when the electric signal pulse is output, each of the plurality of samplers 522 outputs the sampled value (either High or Low) commensurate with the value of the electric signal pulse in question to the addition circuit 524.

The addition circuit 524 adds the sampled values output from the samplers 522 and corresponding to the SPAD group of the pixel P commensurate with the distance measurement conditions. For example, in a case where the pixel P includes the 6×6 SPAD groups, the addition circuit 524 calculates the sum obtained by adding the sampled values output from the samplers 522 corresponding to the SPAD groups. The sum acquired by the addition circuit 524 is output to the histogram creation section 54.

FIG. 4 is a diagram for describing the histogram created by the distance measurement apparatus 1 in an embodiment of the present technology. In the histogram illustrated in FIG. 4, a horizontal axis indicates elapsed time, and the bins are provided according to the sampling intervals. Also, the horizontal axis indicates the sum of the sampled values of the electric signal pulse output at each sampling interval, i.e., the sum of photons. Also, FIG. 4 illustrates examples of the bins corresponding to the sampling interval of 1 ns (sampling frequency of 1 GHz) and the sampling interval of 0.5 ns (sampling frequency of 2 GHz). Also, as will be described later, the histogram in the present example has been calibrated commensurate with an amount of noise caused by external disturbance light.

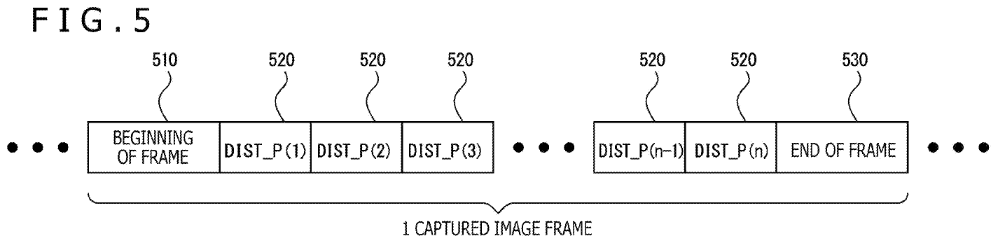

FIG. 5 is a diagram illustrating an example of distance measurement data acquired by the distance measurement apparatus 1 in an embodiment of the present technology. As illustrated in FIG. 5, the distance measurement data is configured, for example, as a data sequence for each captured image frame. Such a data sequence includes, for example, a frame start code 510, pixel-P-by-pixel-P distance measurement data 520, and a frame end code 530. The number assigned to the pixel-P-by-pixel-P distance measurement data 520 indicates the number of the pixel P commensurate with raster scan.

It should be noted that, although the distance measurement process section 50 is configured in such a manner as to externally output the distance measurement data calculated by the distance computation section 56 via the communication interface section 60 in the present disclosure, the distance measurement process section 50 is not limited thereto. For example, as illustrated in other embodiment, the distance measurement apparatus 1 has, as data output modes of the distance measurement process section 50, not only the mode for outputting the distance measurement data but also the mode for outputting echo data related to the data in the vicinity of the peak value in the histogram and the mode for outputting data included in the histogram and is configured in such a manner as to operate according to any one of the output modes.

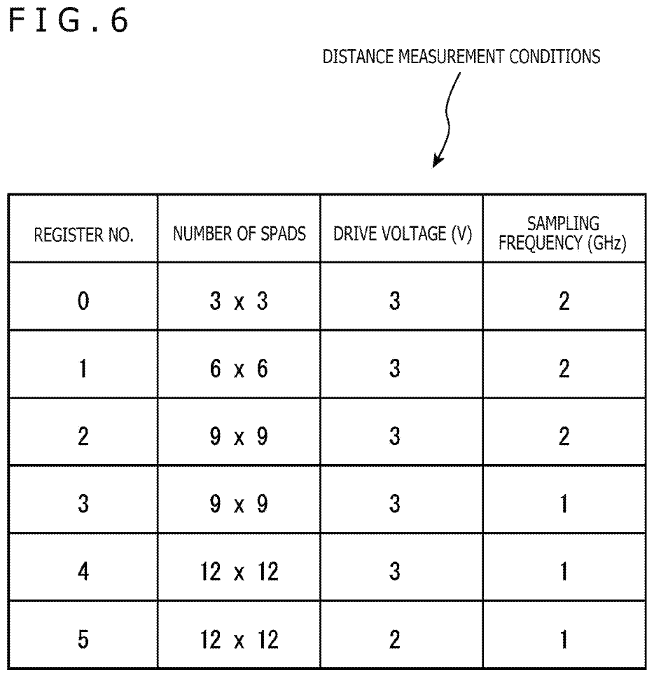

FIG. 6 is a diagram illustrating examples of the distance measurement conditions of the distance measurement apparatus 1 in an embodiment of the present technology. As described above, the plurality of distance measurement conditions is retained in the plurality of registers of the register section 16. As illustrated in FIG. 6, the distance measurement conditions are, for example, a parameter set including a combination of the parameter related to the number of SPADs, the parameter related to the sampling frequency, and the parameter related to a drive voltage. For example, the register with the register number of “1” retains the parameter set including “36” (6×6) as the number of SPADs, “3” (V) as the drive voltage, and “2” (GHz) as the sampling frequency, as the distance measurement conditions of standard distance measurement accuracy. In the present example, the smaller the register number, the lower the resolution in the distance measurement conditions of the parameter set retained in the register. The distance measurement conditions are not limited thereto. Each component that should reference the register section 16 references the enabled register according to the register number specified by the control section 10.

It should be noted that, although five types of the distance measurement conditions have been illustrated in the present example, the distance measurement conditions are not limited thereto. For example, only two types of the distance measurement conditions may be used, such as standard distance measurement accuracy and low or high distance measurement accuracy.

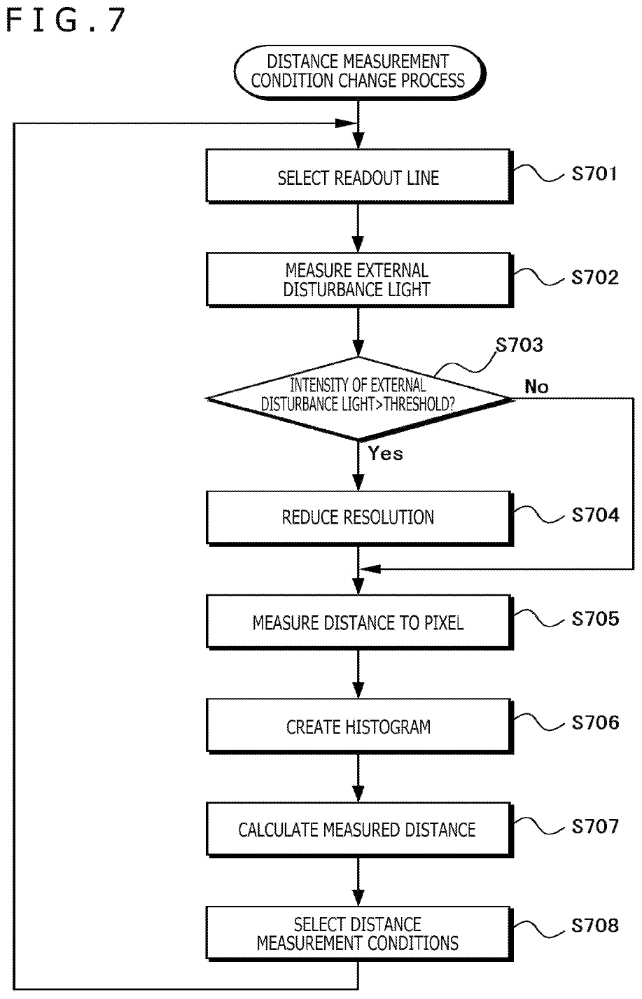

FIG. 7 is a flowchart for describing a distance measurement condition changing process by the distance measurement apparatus 1 in an embodiment of the present technology. The process illustrated in FIG. 7 is performed during the distance measurement process by the distance measurement apparatus 1. Alternatively, the distance measurement apparatus 1 may have a normal mode and a variable distance measurement condition mode and be configured in such a manner as to perform the distance measurement condition changing process in the variable distance measurement condition mode. When activated, the distance measurement apparatus 1 starts measuring the distance according to the distance measurement conditions retained in the specified register of the register section 16. In an initial state, the register that retains the default distance measurement conditions (e.g., register with the register number of “3”), for example, is specified. In the present example, the distance measurement conditions can be selected, for example, for each line in a scanning direction as will be clarified later.

That is, when the distance measurement process is started as illustrated in FIG. 7, the distance measurement apparatus 1 selects the readout line in the captured image frame first (S701). For example, if the distance measurement process has just started, the line in the lowermost row of the captured image frame is selected.

Next, the distance measurement apparatus 1 measures the external disturbance light to eliminate the effects of noise caused by the external disturbance light during the distance measurement (S702). Although the external disturbance light is measured by a similar process to that for the distance measurement, this process differs from that for the distance measurement in that no light is emitted from the light-emitting section 20. More specifically, the control section 10 performs control in such a manner as to drive only the light-receiving section 40 without driving the light-emitting section 20, thus allowing the light-receiving section 40 to output the electric signal pulse from the SPAD group in the readout line commensurate with the current distance measurement conditions. The distance measurement process section 50 decides the sampled value on the basis of the output electric signal pulse according to the predetermined sampling frequency and sets the sum of the sampled values for each pixel P as an initial value of each bin. This allows the histogram to be calibrated commensurate with the effects of the external disturbance light. Next, the distance measurement process section 50 detects the peak value from among these initial values and outputs the peak value to the control section 10. The term “peak value” here refers to an intensity of the measured external disturbance light (amount of noise). As described above, the external disturbance light can be measured with no need for any new component and simply by not driving the light-emitting section 20.

Next, when the peak value in question is received from the distance measurement process section 50, the control section 10 compares the peak value in question with a predetermined threshold to determine whether or not the distance measurement is affected to a large extent by the external disturbance light (S703). In a case where the control section 10 determines that the peak value exceeds the predetermined threshold (Yes in S703), the control section 10 sets the distance measurement conditions in such a manner as to reduce the resolution (S704). That is, in a case where the peak value exceeds the predetermined threshold, the control section 10 switches the register to the one (e.g., register with the register number of “5”) that retains the distance measurement conditions set as the high resolution (upper limit of the resolution) in order to relatively reduce the effects of the external disturbance light. As described above, the distance measurement apparatus 1 can change the distance measurement conditions on the basis of the amount of noise caused by the external disturbance light. In this case, the control section 10 may set the upper limit in such a manner as to prevent the resolution from increasing excessively. As a result, the distance measurement apparatus 1 initiates the actual distance measurement process. It should be noted that, although it has been assumed in the present example that the distance measurement conditions remain unchanged in a case where the intensity of the external disturbance light is equal to or less than the predetermined threshold, the control section 10 is not limited thereto and, for example, may be configured so as to change the distance measurement conditions to those for the low resolution.

In the subsequent distance measurement process, the distance measurement apparatus 1 measures the distance for the pixel P in the currently selected readout line by driving the light-emitting section 20 and the light-receiving section 40 (S705). This allows the light-receiving section 40 to output the electric signal pulse to the distance measurement process section 50 from the SPAD group commensurate with the current distance measurement conditions.

Next, the distance measurement process section 50 creates the histogram by deciding the sampled value while sampling the electric signal pulse in question according to the predetermined sampling frequency, adding the sampled values for each pixel P commensurate with the current distance measurement conditions, and setting that value as the value of the corresponding bin in the histogram (S706). As described above, the histogram is divided into the time bins commensurate with the sampling frequency. Next, the distance measurement process section 50 detects the peak value in the created histogram and calculates the distance from the time corresponding to the peak value in question (S707). The distance measurement process section 50 outputs the data related to the calculated distance (distance measurement data) not only externally via the communication interface section 60 but also to the determination section 12 of the control section 10.

When the distance measurement data is received from the distance measurement process section 50, the control section 10 selects the register that retains the optimal distance measurement conditions on the basis of the distance measurement data in question (S708). More specifically, the control section 10 determines whether or not the distance to the object OBJ is close by comparing the distance measurement data with the predetermined threshold and changes the distance measurement conditions for the next distance measurement commensurate with the determination result in question. First and second thresholds (where the first threshold>the second threshold), for example, are available as the predetermined thresholds.

For example, in a case where the control section 10 determines that the distance measurement data is smaller than the first threshold (i.e., in a case where the object OBJ is close), the control section 10 changes the distance measurement conditions in such a manner as to increase the sampling frequency and/or reduce the resolution. That is, the control section 10 switches the register to the one that retains the distance measurement conditions for which the high sampling frequency has been set (e.g., register with the register number of “2”). The reason for this is to acquire the distance with higher distance measurement accuracy because of the close distance to the object OBJ.

In contrast, in a case where the control section 10 determines that the distance measurement data is larger than the second threshold (i.e., in a case where the object OBJ is far), the control section 10 changes the distance measurement conditions in such a manner as to reduce the sampling frequency and/or increase the resolution. That is, the control section 10 switches the register to the one that retains the distance measurement conditions for which the low sampling frequency has been set. The reason for this is to tolerate lower distance measurement accuracy in the distance measurement because of the far distance to the object OBJ. It should be noted that, in a case where the register that retains the distance measurement conditions for which the low sampling frequency has been set is already selected, the register is not changed. Also, in the present example, the control section 10 does not change the present distance measurement conditions in a case where the distance measurement data is equal to or larger than the first threshold and is equal to or smaller than the second threshold because the distance to the object OBJ is neither close nor far. Also, although the first and second thresholds are available as the predetermined thresholds, the predetermined thresholds are not limited thereto, and more thresholds may be made available, depending on the types of the measurement conditions.

It should be noted that the distance measurement apparatus 1 may, for example, use the peak value of the specific pixel P in the readout line or a mean value of the peak values of the plurality of pixels P in the selection of the distance measurement conditions.

Then, the distance measurement apparatus 1 returns to the process in step S701 to measure the distance for the next readout line. It should be noted that, when the distance measurement process for one captured image frame ends, the distance measurement apparatus 1 returns to the first readout line of the captured image frame and selects this line. As described above, the distance measurement apparatus 1 can change the distance measurement conditions for the next line according to the distance measurement results by the pixels P in the adjacent lines and/or the surrounding pixels P.

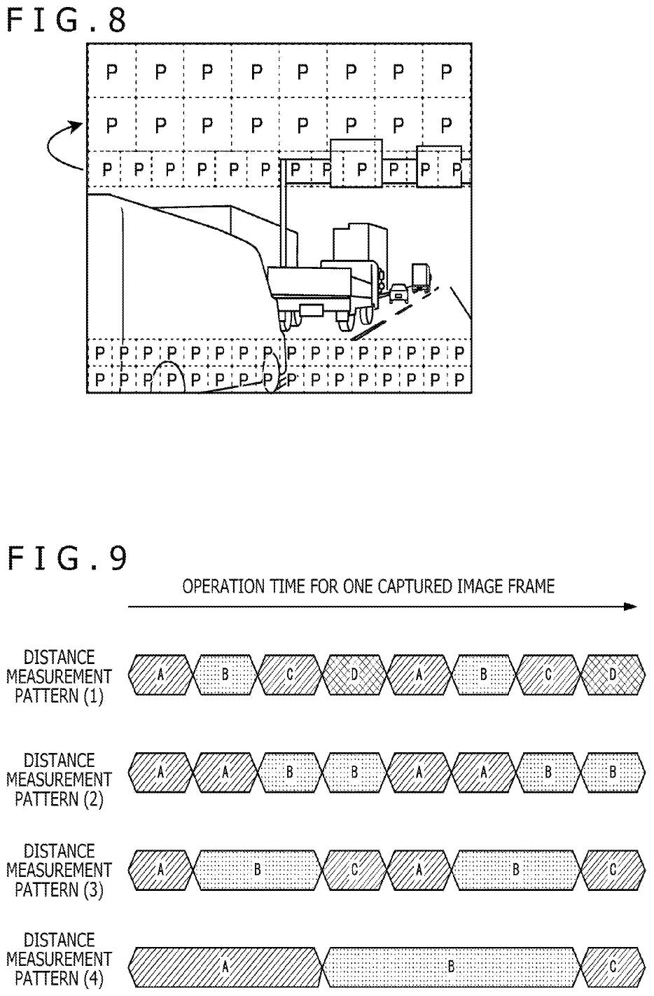

As described above, the distance measurement apparatus 1 measures the distances according to the distance measurement conditions during its operation and can change the distance measurement conditions as appropriate, as illustrated in FIG. 8, depending on the distance to the object OBJ measured by the pixels P in the adjacent lines for which the distance measurement has been performed earlier. Especially, in a case where the distance to the object OBJ is close as a result of the distance measurement, the distance measurement conditions are changed in such a manner as to allow for the distance measurement with higher distance measurement accuracy. This makes it possible to more accurately avoid a collision or other accident, for example, in a scene in front of a vehicle by performing the distance measurement with higher distance measurement accuracy as far as nearby obstacles (e.g., other vehicles) are concerned. Meanwhile, as the result of the measurement, in a case where the distance to the object OBJ is far, the distance measurement conditions are changed in such a manner as to tolerate lower distance measurement accuracy in the distance measurement. As a result, in a case where there is no obstacle (e.g., other vehicle) nearby in the scene in front of the vehicle, for example, it is possible to ensure a reduced drive voltage of the SPADs and a reduced computational load on the processor and suppress power consumption by tolerating the lower distance measurement accuracy in the distance measurement.

It should be noted that, although the example has been illustrated in the present disclosure in which the external disturbance light is measured first in the distance measurement for the captured image frame, the present disclosure is not limited thereto, and the measurement of the external disturbance light may be omitted. Alternatively, for example, the external disturbance light may be measured every several captured image frames and at the first of these frames. This can further suppress power consumption.

### Second Embodiment

A description will be given next of a second embodiment. In the present embodiment which is a modification of the first embodiment, the distance measurement apparatus 1 is disclosed that sequentially switches between the distance measurement conditions (parameter sets) according to a predetermined distance measurement pattern in the single captured image frame.

FIG. 9 is a timing chart for describing examples of the distance measurement patterns in the distance measurement apparatus 1 in an embodiment of the present technology. FIG. 9 illustrates distance measurement patterns (1) to (4) in the operation time for the single captured image frame.

As illustrated in FIG. 9, for example, the distance measurement pattern (1) is a pattern in which distance measurement conditions A to D are repeated. The distance measurement conditions A to D are switched from one to another, for example, every several tens of ns. Such switching can be performed, for example, according to a register number switching pattern. The distance measurement pattern (2) is a pattern that includes the measurement conditions A and B. The distance measurement pattern (3) is a pattern in which the measurement conditions A to C are sequentially repeated and in which the distance measurement condition B is set to last for a long time period to some extent. The distance measurement pattern (4) is a pattern that includes the measurement conditions A to C.

For example, as for the distance measurement pattern (4), the distance measurement condition A set to provide the high distance measurement accuracy is selected to be used for a lower region of the captured image frame where the object OBJ can be present at the close distance. Also, the distance measurement condition B set to provide the medium distance measurement accuracy is selected to be used for the lower region of the captured image frame. Further, the distance measurement condition C set to provide the low distance measurement accuracy is selected to be used for the lower region of the captured image frame. According to such distance measurement patterns, it is possible to selectively and quickly switch between the optimal distance measurement conditions for each region of the captured image frame commensurate with the distance to the object OBJ. As described above, while it has hitherto taken a time of the order of several ms to perform the switching by use of the external host IC or the like, it becomes possible, according to the present technology, to switch between the distance measurement conditions in a short time by making available the patterns of the distance measurement conditions for switching in advance.

It should be noted that, once the distance measurement apparatus 1 selects the predetermined distance measurement pattern and while the distance measurement apparatus 1 performs the distance measurement process according to the selected pattern in the present embodiment, there is no need to change the distance measurement conditions on the basis of the distance measurement for each readout line. Accordingly, for example, the distance measurement apparatus 1 may be configured in such a manner as to determine whether to change the distance measurement pattern every several captured image frames or in such a manner as to change the distance measurement pattern in response to an external instruction.

### Third Embodiment

A description will be given next of a third embodiment. In the present embodiment, the distance measurement apparatus 1 is disclosed that allows for the distance measurement conditions to be changed by using the external host IC that receives the distance measurement data calculated by the distance measurement process section 50. Here, the term “external host IC” is used to mean that the IC is provided outside the distance measurement apparatus 1 as an SoC described in the above embodiment.

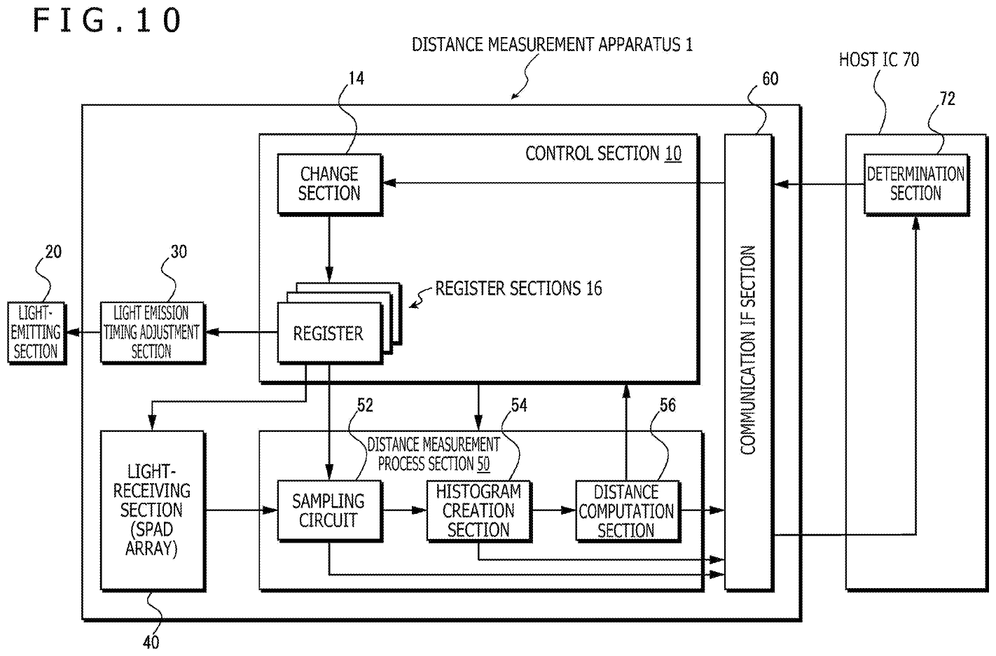

FIG. 10 is a block diagram illustrating a configuration example of the distance measurement apparatus 1 in an embodiment of the present technology. As illustrated in FIG. 10, the distance measurement apparatus 1 of the present embodiment differs from that illustrated in the above embodiments in that a host IC 70 is configured in such a manner as to determine whether or not to change the distance measurement conditions on the basis of the distance measurement data received from the distance measurement process section 50 via the communication interface section 60. It should be noted that the components in FIG. 10 having the same functions or configuration as those already illustrated will be denoted by the same reference signs and that the description thereof will be omitted as appropriate.

As illustrated in FIG. 10, in the present example, the determination section 12 illustrated in FIG. 1 is provided in the host IC 70 without being provided in the control section 10 inside the distance measurement apparatus 1. It should be noted, however, that this does not mean that the provision of the determination section 12 in the control section 10 will be excluded. Although not illustrated, the host IC 70 includes a corresponding communication interface section. When the distance measurement data is received from the distance measurement process section 50 via the communication interface section 60, a determination section 72 of the host IC 70 determines whether or not to change the distance measurement conditions on the basis of the distance indicated by the distance measurement data in question as in the above embodiments. The determination section 72 sends the determination result in question to the control section 10 via the communication interface section 60. The control section 10 hands over the received determination result to the changing section 14, and the changing section 14 switches between the registers of the register section 16 according to the determination result in question.

As an example, the host IC 70 can include a frame buffer (not illustrated) capable of retaining distance measurement data for one captured image frame. A determination section 82 of a host IC 80 determines to which distance measurement condition to change for each readout line in the next captured image frame by referencing the frame buffer.

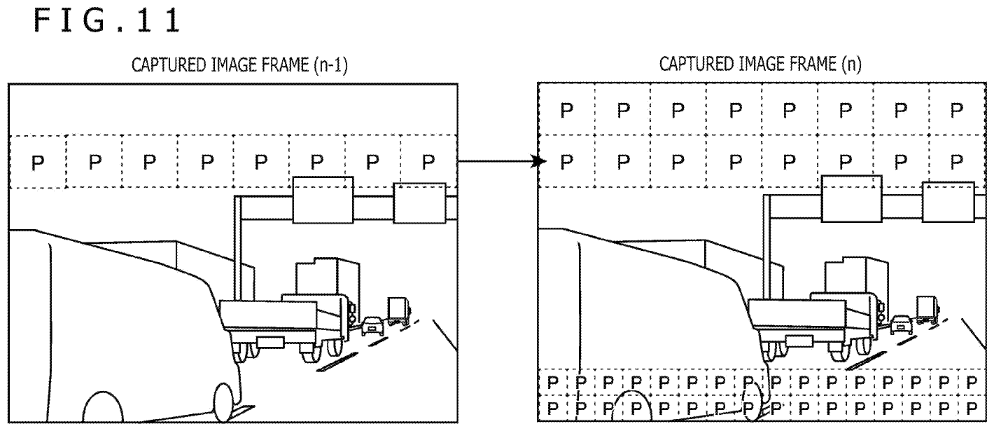

As described above, the present embodiment can also achieve a similar working effect or advantage to that by the above embodiments. Also, according to the present embodiment, the determination section 72 of the host IC 70 determines whether or not to change the distance measurement conditions on the basis of the distance measurement data of the pixel P at the same position in the past captured image frame, as illustrated in FIG. 11, thus making it possible to change the current distance measurement conditions, depending on the determination result in question during the formation of the current captured image frame.

It should be noted that, although the configuration in which the external host IC 70 includes the determination section 72 has been described in the above embodiments, the distance measurement apparatus 1 is not limited thereto, and the control section 10 inside the SoC may also include the determination section 12. For example, the distance measurement apparatus 1 may have a first mode in which the determination section 12 provided inside the SoC performs the determination process and a second mode in which the determination section 82 provided in the external host IC 80 performs the determination process in such a manner that the distance measurement apparatus 1 is selectively switched to one of the modes to operate.

### Fourth Embodiment

A description will be given next of a fourth embodiment. In the present embodiment, the distance measurement apparatus is disclosed in which the external host IC performs the distance measurement process in place of the distance measurement process section 50 described above.

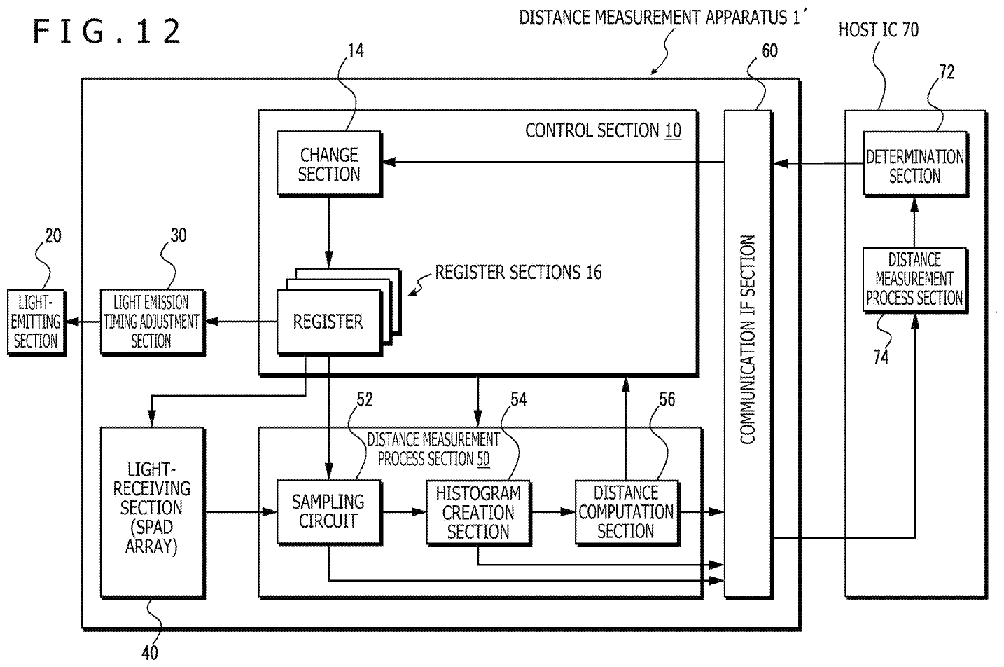

FIG. 12 is a block diagram illustrating a configuration example of the distance measurement apparatus in an embodiment of the present technology. As illustrated in FIG. 12, in a distance measurement apparatus 1′ of the present embodiment, the host IC 70 differs from that illustrated in the above embodiments in that the host IC 70 includes the determination section 72 and a distance measurement process section 74 that has functions equivalent to those of the distance measurement process section 50 of a sensor-side chip. Although the determination section 12 is not clearly illustrated in the control section 10 in FIG. 12, the determination section 12 may be provided in the control section 10 as in the first embodiment or the like. It should be noted that the components in FIG. 12 having the same functions or configuration as those already illustrated will be denoted by the same reference signs and that the description thereof will be omitted as appropriate.

The distance measurement apparatus 1′ is typically configured in such a manner as to operate in a plurality of data output modes. For example, the distance measurement apparatus 1 has a mode in which the sampling circuit 52 outputs the echo data for each pixel P (sum of the chronologically sampled values) to the host IC 70, a mode in which the histogram creation section 54 outputs histogram data to the host IC 70, and a mode in which the distance computation section 56 outputs the distance measurement data to the host IC 70.

The distance measurement process section 50 on the sensor-side chip operates in one of the data output modes under control of the control section 10 and outputs predetermined data to the host IC 70 via the communication interface section 60.

The host IC 70 performs, on the basis of the data sent from the distance measurement process section 50, the process commensurate with the type of that data, calculates the distance measurement data, and outputs the calculated data to the determination section 72. For example, the distance measurement process section 74 creates the histogram on the basis of the received echo data, determines the peak value from the created histogram in question, and calculates the distance measurement data. Alternatively, in a case where the received data is the histogram data, the distance measurement process section 74 determines the peak value from the histogram and calculates the distance measurement data.

As described above, the present embodiment can also achieve a similar working effect or advantage to that by the above embodiments. Especially, while the host IC 70 takes charge of the distance measurement process that requires high performance, the register switching is performed by the control section 10, thus allowing the distance measurement conditions to be changed flexibly and quickly.

The above embodiments are illustrative for description of the present technology and do not purport to limit the present technology only to these embodiments. The present technology can be performed in various ways without departing from the gist thereof.

For example, in the method described in the present specification, the steps, operation, or functions can be performed in parallel or in a different order unless inconsistency arises in the result. The described steps, operation, and functions are provided as mere examples, and some of the steps, operation, and functions can be omitted without departing from the gist of the technology or may be combined into one. Alternatively, other steps, operation, or functions may be added.

Also, although various embodiments are disclosed in the present specification, it is possible to improve a specific feature (technical matter) in one embodiment as appropriate and add that feature to other embodiment or replace a specific feature in the other embodiment in question therewith, and such an embodiment is also included in the gist of the present technology.

For example, although a mode has been described in the above embodiments in which the measurement conditions defined as the parameter set determined in advance are changed by selectively switching the registers of the register section 16 from one to another, the distance measurement apparatus 1 is not limited thereto. For example, the distance measurement apparatus 1 may be configured in such a manner that the changing section 14 of the control section 10 dynamically generates the parameter set, depending on the calculated distance and rewrites the contents of the register referenced by the generated parameter set.

It should be noted that the present technology can also adopt the following configurations:

(1)

A distance measurement apparatus including:

a light-emitting section adapted to emit light to a target area;

a light-receiving section including a plurality of light-receiving elements that receives observation light in the target area to output an electric signal;

a distance measurement process section adapted to perform, according to predetermined distance measurement conditions and in a captured image frame formed by the plurality of light-receiving elements, a distance measurement process for calculating a distance to an object on the basis of an electric signal commensurate with reflected light from the object to which the light emitted from the light-emitting section has been applied, the reflected light being included in the observation light received by some light-receiving element groups of the plurality of light-receiving elements included in the pixel; and a control section adapted to control the predetermined distance measurement conditions, in which the control section changes the predetermined distance measurement conditions while the current captured image frame is formed.

(2)

The distance measurement apparatus of feature (1), in which

the control section performs control in such a manner that some light-receiving element groups of the plurality of light-receiving elements receive ambient light before light is emitted by the light-emitting section,

the distance measurement process section calculates an amount of noise on the basis of the ambient light, and

the control section changes the predetermined distance measurement conditions on the basis of the calculated amount of noise.

(3)

The distance measurement apparatus of feature (1) or (2), in which

in a case where the amount of noise exceeds a predetermined threshold, the control section changes the predetermined distance measurement conditions in such a manner as to increase the number of the light-receiving element groups included in the pixel.

(4)

The distance measurement apparatus of any one of features (1) to (3), in which

the control section changes the predetermined distance measurement conditions on the basis of the distance calculated by the distance measurement process section.

(5)

The distance measurement apparatus of any one of features (1) to (4), in which

the control section determines, on the basis of the distance calculated by light reception by some light-receiving element groups of the plurality of light-receiving elements in a first line of the captured image frame, whether or not to change the predetermined distance measurement conditions for a second line that follows the first line.

(6)

The distance measurement apparatus of any one of features (1) to (5), in which

the control section determines, on the basis of a mean value of the distances calculated in the first line, whether or not to change the predetermined distance measurement conditions for the second line.

(7)

The distance measurement apparatus of any one of features (1) to (6), in which

the control section changes the predetermined distance measurement conditions on the basis of the distance calculated by the distance measurement process section in the past captured image frame.

(8)

The distance measurement apparatus of any one of features (1) to (7), in which

the control section changes the predetermined distance measurement conditions in such a manner that the closer the calculated distance, the larger the number of the light-receiving element groups included in the pixel.

(9)

The distance measurement apparatus of any one of features (1) to (8), in which

the control section changes the predetermined distance measurement conditions in such a manner that the closer the calculated distance, the higher a sampling frequency for sampling the electric signal.

(10)

The distance measurement apparatus of any one of features (1) to (9), in which

the distance measurement process section includes
a sampling circuit adapted to sample, at a predetermined sampling frequency, the electric signal output by each pixel that includes some light-receiving element groups of the plurality of light-receiving elements, the electric signal being commensurate with the predetermined distance measurement conditions, and to output a sampled value,
a histogram creation section adapted to create a histogram indicating intensity of the reflected light for each time zone on the basis of a plurality of the sampled values acquired by the light emission and the light reception, and
a distance computation section adapted to detect a peak value in the histogram and calculate the distance from the detected peak value.
   (11)

The distance measurement apparatus of feature (10), in which

the control section determines whether or not to change the predetermined distance measurement conditions each time the histogram is created by the histogram creation section.

(12)

The distance measurement apparatus of any one of features (1) to (11), being configured as a system-on-chip (SoC) including registers that retain a plurality of parameter sets indicating the predetermined distance measurement conditions.

(13)

The distance measurement apparatus of any one of features (1) to (12), further including:

a communication interface, in which

the distance measurement process section outputs data related to the calculated distance for each of the pixels for the captured image frame via the communication interface.

(14)

The distance measurement apparatus of any one of features (1) to (13), in which

the control section changes the predetermined distance measurement conditions by selecting any of the plurality of parameter sets retained in the registers without communicating with equipment outside the SoC via the communication interface.

(15)

A distance measurement method including:

emitting light to a target area from a light-emitting section;

receiving observation light in the target area with a light-receiving section including a plurality of light-receiving elements and outputting an electric signal;

performing, according to predetermined distance measurement conditions and in a captured image frame formed by the plurality of light-receiving elements, a distance measurement process for calculating a distance to an object on the basis of an electric signal commensurate with reflected light from the object to which the light emitted from the light-emitting section has been applied, the reflected light being included in the observation light received by some light-receiving element groups of the plurality of light-receiving elements included in the pixel; and

performing control in such a manner as to change the predetermined distance measurement conditions while the current captured image frame is formed so as to ensure that the distance to the object is calculated with the predetermined distance measurement conditions.

### REFERENCE SIGNS LIST

1: Distance measurement apparatus
10: Control section
12: Determination section
14: Changing section
16: Register section
20: Light-emitting section
30: Light emission timing adjustment section
40: Light-receiving section
50: Distance measurement process section
52: Sampling circuit
54: Histogram creation section
56: Distance computation section
60: Communication interface section
70: Host IC
72: Determination section
74: Distance measurement process section

1. A distance measurement apparatus comprising:
a light-emitting section adapted to emit light to a target area;
a light-receiving section including a plurality of light-receiving elements that receives observation light in the target area to output an electric signal;
a distance measurement process section adapted to perform, according to predetermined distance measurement conditions and in a captured image frame formed by the plurality of light-receiving elements, a distance measurement process for calculating a distance to an object on a basis of an electric signal commensurate with reflected light from the object to which the light emitted from the light-emitting section has been applied, the reflected light being included in the observation light received by some light-receiving element groups of the plurality of light-receiving elements included in a pixel; and
a control section adapted to control the predetermined distance measurement conditions, wherein
the control section changes the predetermined distance measurement conditions while the current captured image frame is formed.

2. The distance measurement apparatus according to claim 1, wherein
the control section performs control in such a manner that some light-receiving element groups of the plurality of light-receiving elements receive ambient light when light is not emitted by the light-emitting section,
the distance measurement process section calculates an amount of noise on a basis of the ambient light, and
the control section changes the predetermined distance measurement conditions on a basis of the calculated amount of noise.

3. The distance measurement apparatus according to claim 2, wherein
in a case where the amount of noise exceeds a predetermined threshold, the control section changes the predetermined distance measurement conditions in such a manner as to increase the number of the light-receiving element groups included in the pixel.

4. The distance measurement apparatus according to claim 1, wherein
the control section changes the predetermined distance measurement conditions on a basis of the distance calculated by the distance measurement process section.

5. The distance measurement apparatus according to claim 4, wherein
the control section determines, on a basis of the distance calculated by light reception by some light-receiving element groups of the plurality of light-receiving elements in a first line of the captured image frame, whether or not to change the predetermined distance measurement conditions for a second line that follows the first line.

6. The distance measurement apparatus according to claim 5, wherein
the control section determines, on a basis of a mean value of the distances calculated in the first line, whether or not to change the predetermined distance measurement conditions for the second line.

7. The distance measurement apparatus according to claim 4, wherein
the control section changes the predetermined distance measurement conditions on a basis of the distance calculated by the distance measurement process section in the past captured image frame.

8. The distance measurement apparatus according to claim 4, wherein
the control section changes the predetermined distance measurement conditions in such a manner that the closer the calculated distance, the larger the number of the light-receiving element groups included in the pixel.

9. The distance measurement apparatus according to claim 4, wherein
the control section changes the predetermined distance measurement conditions in such a manner that the closer the calculated distance, the higher a sampling frequency for sampling the electric signal.

10. The distance measurement apparatus according to claim 1, wherein
the distance measurement process section includes
a sampling circuit adapted to sample, at a predetermined sampling frequency, the electric signal output by each pixel that includes some light-receiving element groups of the plurality of light-receiving elements, the electric signal being commensurate with the predetermined distance measurement conditions, and to output a sampled value,
a histogram creation section adapted to create a histogram indicating intensity of the reflected light for each time zone on a basis of a plurality of the sampled values acquired by the light emission and the light reception, and
a distance computation section adapted to detect a peak value in the histogram and calculate the distance from the detected peak value.

11. The distance measurement apparatus according to claim 10, wherein
the control section determines whether or not to change the predetermined distance measurement conditions each time the histogram is created by the histogram creation section.

12. The distance measurement apparatus according to claim 1, being configured as a system-on-chip (SoC) including registers that retain a plurality of parameter sets indicating the predetermined distance measurement conditions.

13. The distance measurement apparatus according to claim 12, further comprising:
a communication interface, wherein
the distance measurement process section outputs data related to the calculated distance for each of the pixels for the captured image frame via the communication interface.

14. The distance measurement apparatus according to claim 13, wherein
the control section changes the predetermined distance measurement conditions by selecting any of the plurality of parameter sets retained in the registers without communicating with equipment outside the SoC via the communication interface.

15. A distance measurement method comprising:
emitting light to a target area from a light-emitting section;
receiving observation light in the target area with a light-receiving section including a plurality of light-receiving elements and outputting an electric signal;
performing, according to predetermined distance measurement conditions and in a captured image frame formed by the plurality of light-receiving elements, a distance measurement process for calculating a distance to an object on a basis of an electric signal commensurate with reflected light from the object to which the light emitted from the light-emitting section has been applied, the reflected light being included in the observation light received by some light-receiving element groups of the plurality of light-receiving elements included in a pixel; and
performing control in such a manner as to change the predetermined distance measurement conditions while the current captured image frame is formed so as to ensure that the distance to the object is calculated with the predetermined distance measurement conditions.
